(19) United States
(12) Patent Application Publication
(10) Pub. No.: US 2006/0098400 A1
(43) Pub. Date: May 11, 2006

(54) Detachable computer bezel

(76) Inventor: Roger Lin, Chung-Ho City (TW)

Correspondence Address: HDSL, 4331 STEVENS BATTLE LANE, FAIRFAX, VA, 22033, US

(21) Appl. No.: 10/984,203

(22) Filed: Nov. 10, 2004

(51) Int. Cl. G06F 1/16

(52) U.S. Cl. 361/683; 312/223.1

(57) ABSTRACT

A detachable computer bezel that is to be installed onto a computer chassis. The computer bezel has connected a link device with a plurality of locking portions. The link device opposes to one surface of the computer chassis. The link device has at least one sliding slot. The computer bezel includes at least one corresponding orienting element for limiting the link device to moving within a fixed stroke. The computer bezel can be attached to and detached from the computer chassis through the displacement of the link device.

### BACKGROUND OF THE INVENTION

The present invention relates in general to a detachable computer bezel, and more particularly, to a computer bezel that is attached to and detached from a computer chassis without the need of any tools or complicated installation and removal procedures.

The conventional art uses screws or plastic retainers to secure a computer bezel to a computer chassis. To further install a periphery device to a computer, the screws securing the computer bezel must be removed in order to detach the computer bezel from the computer chassis. When screws are utilized to secure the bezel to the computer chassis, tools such as a screwdriver are required for any further removal of the bezel. The utilization of screws for securing the bezel to the chassis is, therefore, inconvenient for consumers. Besides, the installation and removal of the computer bezel through the use of plastic retainers is very complicated, which makes it easy for consumers to inadvertently damage the computer bezel during its installation or removal. In short, the conventional art cannot meet the real world demands of the consumer.

### BRIEF SUMMARY OF THE INVENTION

The present invention provides a detachable computer bezel. By means of a link device, the computer bezel can be attached to and detached from a computer chassis without the need of any tools or complicated installation and removal procedures.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 illustrates the disposition of a detachable computer bezel of one embodiment in accordance with the present invention.

FIG. 2 illustrates a side view of the computer bezel of FIG. 1 and a corresponding computer chassis.

FIG. 3 illustrates a condition that a locking element of the computer bezel is pushed upward during an attachment of the computer bezel to the computer chassis.

FIG. 4 illustrates a condition that the locking element of the computer bezel hooks the inner wall of the computer chassis after the attachment.

FIG. 5 illustrates a condition that the locking element of the computer bezel has been pushed upward during a detachment of the computer bezel from the computer chassis.

FIG. 6 illustrates a condition that the locking element of the computer bezel has been withdrawn from the through holes of the computer chassis.

FIG. 7 illustrates the disposition of a detachable computer bezel of another embodiment in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

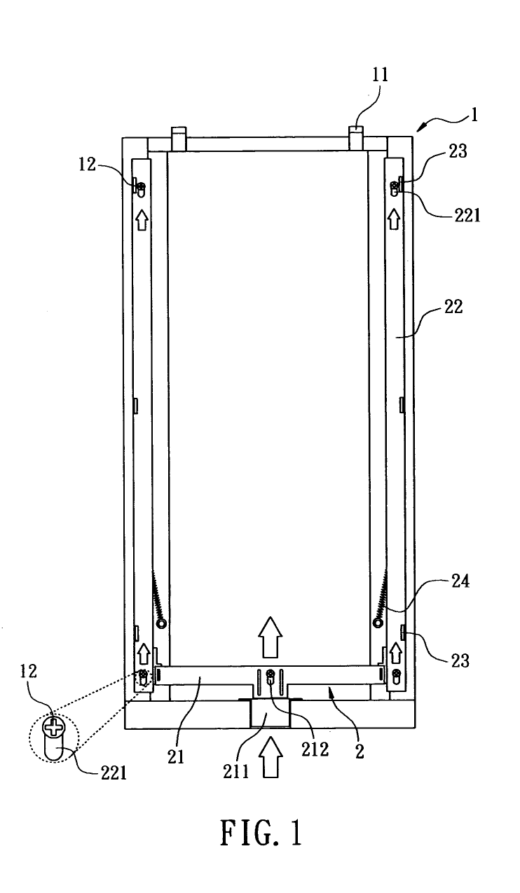

Referring to FIG. 1, the disposition of a detachable computer bezel in accordance with the present invention is shown. Between a computer bezel 1 and a computer chassis 3, a link device 2 is disposed to facilitate the installation and removal of the computer bezel 1. The computer bezel 1 is able to attach to and detach from the computer chassis 3 without requiring tools or any complicated installation and removal procedures.

The link device 2 can be fixed to either the computer bezel 1 or the computer chassis 3. In the present embodiment, the link device 2 is fixed to the computer bezel 1. The link device 2 includes a connecting member 21 with an actuating key 211, and two side braces 22 disposed at each end of the connecting member 21. The connecting member 21 and the actuating key 211 are disposed at the bottom of the computer bezel 1. Each side brace 22 has a plurality of longitudinal locking portions 23. Each locking portion 23 is shaped into a hook. The link device 2 further includes at least one resilient element 24 that is able to restore the link device 2 to its default position. The computer bezel 1 has at least one tab 11 formed at one end thereof and at least one orienting element 12. Corresponding to the orienting elements 12 of the computer bezel 1, the connecting member 21 has at least one longitudinal sliding slot 212, and the side braces 22 has at least one longitudinal sliding slot 221, which are respectively formed at suitable places thereof. The displacement of the link device 2 is thereby limited by the sliding slots 212, 221.

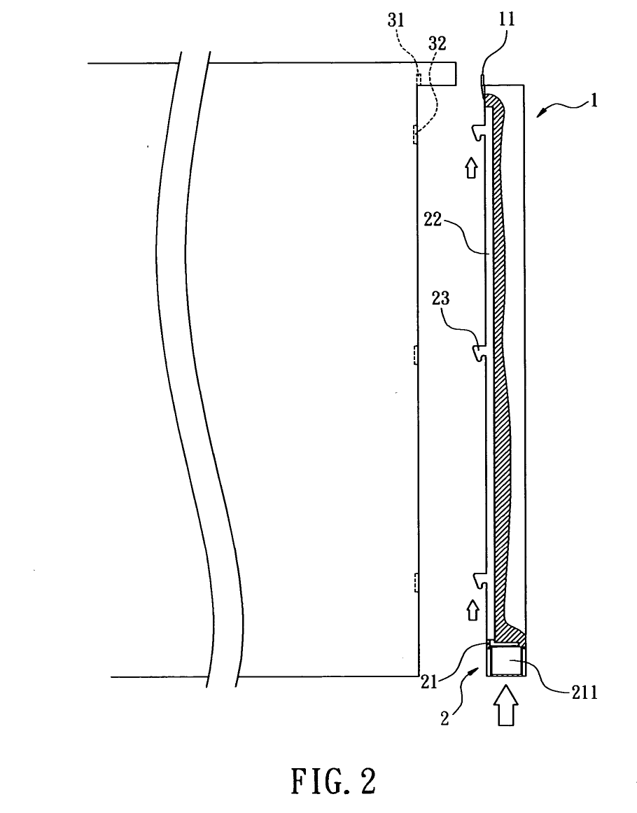

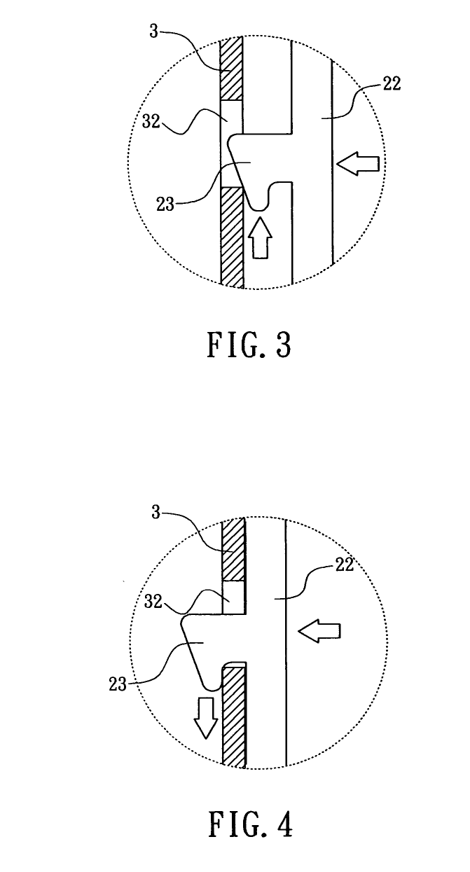

Referring to FIGS. 2 through 4, the installation of the computer bezel 1 onto the computer chassis 3 is illustrated. The link device 2 of the computer bezel 1 is oriented to face directly to the computer chassis 3. The tabs 11 located at one end of the computer bezel 1 are inserted into a fixing hole 31 of the computer chassis 3. The other end of the computer bezel 1 is then moved toward the computer chassis 3. At the same time, the actuating key 211 of the link device 2 is pushed to align the locking portions 23 of the side brace 22 to corresponding through holes 32 of the computer chassis 3, as shown in FIG. 3. The locking portions 23 are then respectively inserted into their corresponding through holes 32. After the locking portions 23 have been inserted into the through holes, the link device 2 is released from the force applying at the actuating key 211. The resilient element 24 retracts and pulls the link device 2 back to its default position. The locking portions 23 then hook against the inner wall of the computer chassis 3, as shown in FIG. 4. The computer bezel 1 is thereby secured to the computer chassis 3.

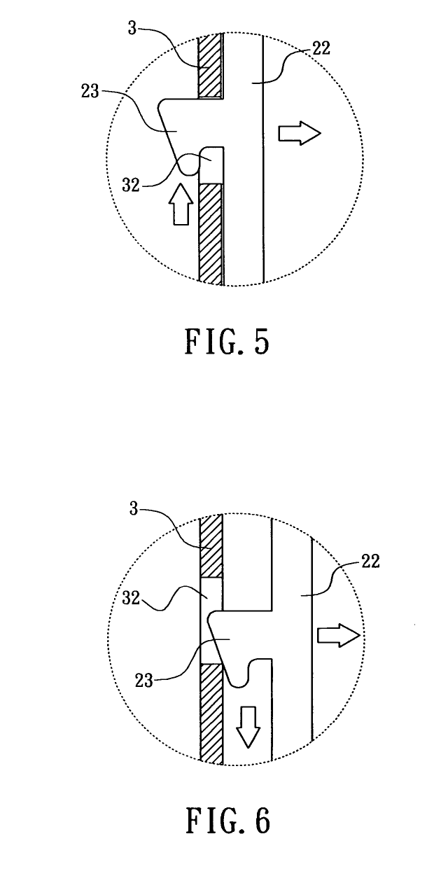

Referring to FIGS. 5 and 6, the removal of the computer bezel 1 from the computer chassis 3 is illustrated. To further install a periphery device to a computer, the computer bezel 1 must be detached from the computer chassis 3. The actuating key 211 of the link device 2 is pushed by a consumer to lift up the link device 2. This lift raises the locking portions 23 and allows the locking portion 23 to be withdrawn from the through holes 32 of the computer chassis 3, as shown in FIG. 5. Further moving the computer bezel 1 outward and downward will detach the computer bezel 1 from the computer chassis 3, as shown in FIG. 6. The interior of the computer chassis 3 is thereby exposed for installation of periphery devices.

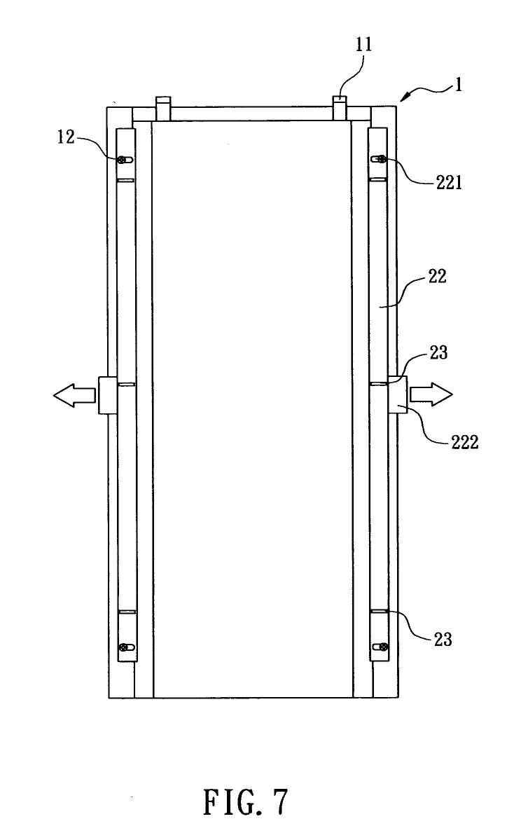

Referring to FIG. 7, another embodiment of the present invention is shown. The link device 2 comprises two side braces 22 disposed respectively at both sides of the computer bezel 1. Each side brace 22 comprises an actuating key 222 that is installed at the central exterior thereof, and a plurality of lateral locking portions 23. Each locking portion 23 is shaped into a hook. The computer bezel 1 has at least one tab 11 formed at one end thereof and at least one orienting element 12. Each side brace 22 has correspondingly lateral sliding slot 221 opposite to the orienting element 12. The orienting elements 12 and the lateral sliding slots 221 limit the link device 2 to moving within a fixed stroke. Further, by moving the side brace 22 leftward or rightward, the computer bezel 1 can be attached to and detached from the computer chassis 3 without the need of any tools.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A detachable computer bezel that is to be installed onto a computer chassis, the computer bezel having connected a link device with a plurality of locking portions, the link device opposing to one surface of the computer chassis, the link device having at least one sliding slot, the computer bezel having at least one orienting element respectively corresponding to each sliding slot for limiting the link device to moving within a fixed stroke, and whereby the computer bezel can be attached to and detached from the computer chassis through the displacement of the link device.

2. The detachable computer bezel of claim 1, wherein the computer chassis has a plurality of through holes opposing to the locking portions of the link device.

3. The detachable computer bezel of claim 1, wherein the computer bezel has at least one tab protruding from one end thereof, and the computer chassis has at least one corresponding fixing hole.

4. The detachable computer bezel of claim 1, wherein a resilient element is disposed between the computer chassis and the computer bezel.

5. The detachable computer bezel of claim 1, wherein the locking portion of the link device is shaped into a hook.

6. The detachable computer bezel of claim 1, wherein the link device further comprises two side braces with the locking portions formed thereon.

7. The detachable computer bezel of claim 6, wherein the link device further comprises a connecting member with an actuating key at the middle thereof, the side braces respectively connecting to each end of the connecting member.

8. The detachable computer bezel of claim 6, wherein each side brace further comprises an actuating key connected to the central exterior thereof.

9. A detachable computer bezel that is to be installed onto a computer chassis, the computer chassis having connected a link device with a plurality of locking portions, the link device opposing to one surface of the computer bezel, the link device having at least one sliding slot, the computer chassis having at least one orienting element respectively corresponding to each sliding slot for limiting the link device to moving within a fixed stroke, and whereby the computer bezel can be attached to and detached from the computer chassis through the displacement of the link device.
